(19) United States
(12) Patent Application Publication
(10) Pub. No.: US 2025/0079080 A1
(43) Pub. Date: Mar. 6, 2025

(54) INTERNAL ELECTRODE COMPOSITION OF MUTI LAYER CERAMIC CAPACITOR FOR VEHICLES

(71) Applicant: SAMHWA CAPACITOR CO., LTD., Yongin-si (KR)

(72) Inventors: Young Joo OH, Seoul (KR); Jung Rag YOON, Yongin-si (KR); Seock No SEO, Osan-si (KR)

(21) Appl. No.: 18/811,336

(22) Filed: Aug. 21, 2024

(30) Foreign Application Priority Data
Sep. 5, 2023 (KR) 10-2023-0117479

(51) Int. Cl. H01G 4/008; B22F 1/12; C22C 19/03; H01G 4/30

(52) U.S. Cl. CPC H01G 4/0085; B22F 1/12; C22C 19/03; B22F 2301/15; B22F 2302/35; B22F 2999/00; H01G 4/30

(57) ABSTRACT

Provided is an internal electrode composition of a multi-layer ceramic capacitor for a vehicle, which includes metal powder and a ceramic base substance, wherein the metal powder includes Ni of 79 to 91.9% by weight (wt %), and Sn of 0.1 to 2.0 wt %, and the ceramic base substance includes BaTiO₃ of 7.5 to 15 wt %, and MgCO₃ of 0.5 to 4.0 wt %, and a specific surface area of MgCO₃ is greater than a specific surface area of BaTiO₃.

### TECHNICAL FIELD

The present disclosure relates to an internal electrode composition of a multi-layer ceramic capacitor for a vehicle. Particularly, the present disclosure relates to an internal electrode composition of a multi-layer ceramic capacitor for a vehicle, which prevents coverage characteristics from being reduced due to a sintering delay of an internal electrode, while minimizing the content of a ceramic base substance such as BaTiO₃ for controlling firing shrinkage rates between Ni metal and dielectric ceramic generated during sintering, and prevents the diffusion of BaTiO₃ to the dielectric, thereby preventing the thickness of the dielectric from increasing, and thus increasing the withstand voltage or capacity of the multi-layer ceramic capacitor or reducing the leakage current, to accordingly improve reliability by enhancing high-temperature insulation resistance characteristics.

### BACKGROUND ART

Multi-layer ceramic capacitors (MLCCs) are manufactured as high-capacity, high-voltage, and high-reliability products according to enlargement of an application range of electric vehicles. MLCCs realize high capacity by increasing the number of stacks by forming the thickness of the dielectric sheets or internal electrodes as thin films.

When the internal electrodes are formed as thin films, if the sintering shrinkage is severe, the internal electrodes may be broken or agglomerated, and thus product defects may occur due to a decrease in the capacitance of the multi-layer ceramic capacitor or a short circuit between the internal electrodes.

Korean Patent Publication No. 10-1383253 (Patent Document 1) relates to a method of manufacturing metal paste for internal electrodes of multi-layer ceramic capacitors to solve the aforementioned problems.

The metal paste for internal electrodes, which is manufactured as in Patent Document 1, may minimize a reaction between a dielectric and an electrode during sintering by adding nano glass to which rare earth elements are added to ceramic base substance powder, may allow the internal electrodes to have a uniform thickness when manufacturing the internal electrodes as thin layers, and may stabilize a sintering temperature of the internal electrodes to minimize a difference in shrinkage rate with the dielectric.

The ceramic base substance powder used in the conventional internal electrode, such as Patent Document 1, may minimize a difference in shrinkage rate between the internal electrode and the dielectric, but when the content thereof is increased, the content of BaTiO₃, which is frequently used as a main raw material of the ceramic base substance powder, is increased.

The increase in the content of BaTiO₃ reduces coverage characteristics due to the sintering delay of the internal electrode and increases the thickness of the dielectric layer due to BaTiO₃ diffused into the dielectric layer, thereby causing a problem of reducing the withstand voltage or capacity of the multi-layer ceramic capacitor or increasing the leakage current in the secondary phase.

### SUMMARY OF THE INVENTION

### Technical Problem

In order to solve the problem described above, it is an object of the present disclosure to provide an internal electrode composition of a multi-layer ceramic capacitor for a vehicle, which prevents coverage characteristics from being reduced due to a sintering delay of an internal electrode, while minimizing the content of a ceramic base substance such as BaTiO₃ for controlling firing shrinkage rates between Ni metal and dielectric ceramic generated during sintering, and prevents the diffusion of BaTiO₃ to the dielectric, thereby suppressing an increase in the thickness of the dielectric, and thus increasing the withstand voltage or capacity of the multi-layer ceramic capacitor or reducing the leakage current, to accordingly improve reliability by enhancing high-temperature insulation resistance characteristics.

It is another object of the present disclosure to provide an internal electrode composition of a multi-layer ceramic capacitor for a vehicle, which minimizes sintering and reactivity with the dielectric by adding MgCO₃ to a ceramic base substance, although a less amount of BaTiO3, which is used as the ceramic base substance, is added, to thereby improve the reliability of multi-layer ceramic capacitor products that may increase the capacity of multi-layer ceramic capacitors or reduce leakage current.

It is another object of the present disclosure to provide an internal electrode composition of a multi-layer ceramic capacitor for a vehicle, which forms an insulating active layer between a dielectric and an internal electrode interface by adding tin (Sn) to metal powder, to thereby increase the reliability of the product of the multi-layer ceramic capacitor.

### Technical Solution

According to an aspect of the present disclosure, there is provided an internal electrode composition of a multi-layer ceramic capacitor for a vehicle, the internal electrode composition including metal powder and a ceramic base substance, wherein the metal powder includes Ni and Sn, and the ceramic base substance includes BaTiO₃ and MgCO₃, where Ni of 79 to 91.9% by weight (wt %), Sn of 0.1 to 2.0 wt %, BaTiO₃ of 7.5 to 15 wt %, and MgCO₃ of 0.5 to 4.0 wt %, are mixed, and a specific surface area (by BET (Brunauer, Emmett, Teller)) of MgCO₃ is greater than a specific surface area by BET of BaTiO₃.

An internal electrode composition of a multi-layer ceramic capacitor for a vehicle, according to the present disclosure, prevents coverage characteristics from being reduced due to a sintering delay of an internal electrode, while minimizing the content of a ceramic base substance such as BaTiO₃ for controlling firing shrinkage rates between Ni metal and dielectric ceramic generated during sintering, and prevents the diffusion of BaTiO₃ to the dielectric, thereby preventing the thickness of the dielectric from increasing, and thus providing advantages of increasing the withstand voltage or capacity of the multi-layer ceramic capacitor or reducing the leakage current, to accordingly improve reliability by enhancing high-temperature insulation resistance characteristics.

In addition, the internal electrode composition of a multi-layer ceramic capacitor for a vehicle, according to the present disclosure, minimizes sintering and reactivity with the dielectric by adding MgCO₃ to a ceramic base substance, although a less amount of BaTiO₃, which is used as the ceramic base substance, is added, to thereby provide an advantage of improving the reliability of multi-layer ceramic capacitor products that may increase the capacity of multi-layer ceramic capacitors or reduce leakage current. In addition, the internal electrode composition of a multi-layer ceramic capacitor for a vehicle, according to the present disclosure, forms an insulating active layer between a dielectric and an internal electrode interface by adding tin (Sn) to metal powder, to thereby provide an advantage of increasing the reliability of the product of the multi-layer ceramic capacitor.

### BRIEF DESCRIPTION OF THE DRAWINGS

FIG. 1 is a flowchart of a process of manufacturing a paste for an internal electrode using an internal electrode composition of a multi-layer ceramic capacitor for a vehicle according to the present disclosure.

FIG. 2 is a cross-sectional view of a multi-layer ceramic capacitor manufactured using the paste for an internal electrode illustrated in FIG. 1.

### DETAILED DESCRIPTION OF THE INVENTION

Hereinafter, an internal electrode composition of a multi-layer ceramic capacitor for a vehicle according to an embodiment of the present disclosure is described with reference to the accompanying drawings.

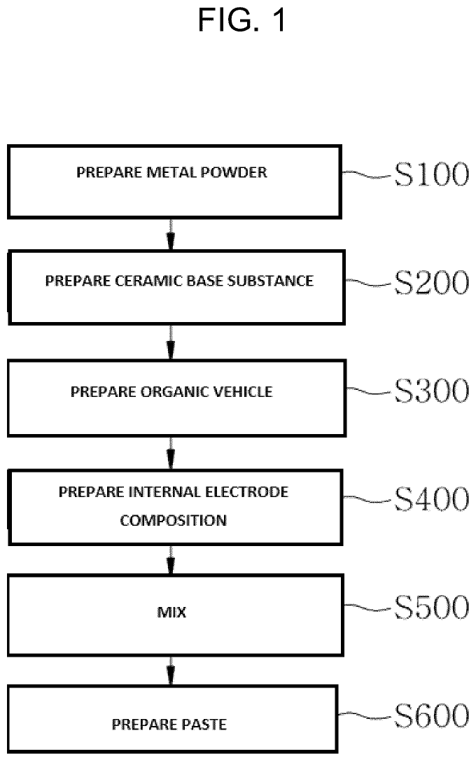

As shown in FIG. 1, an internal electrode composition of the multi-layer ceramic capacitor for a vehicle according to an embodiment of the present disclosure includes metal powder and a ceramic base substance. The metal powder includes Ni and Sn, and the ceramic base substance includes BaTiO₃ and MgCO₃.

The internal electrode composition of the multi-layer ceramic capacitor for a vehicle according to an embodiment of the present disclosure is specifically formed by mixing Ni of 79 to 91.9 wt %, Sn of 0.1 to 2.0 wt %, BaTiO₃ of 7.5 to 15 wt %, and MgCO₃ of 0.5 to 4.0 wt %.

A specific surface area (by BET) of MgCO₃ is greater than a specific surface area (by BET) of BaTiO₃, and in particular, the specific surface area of MgCO₃ is 1.4 to 5.0 times as large as the specific surface area of BaTiO₃, BaTiO₃ of the ceramic base substance has the specific surface area of 20 to 60 m²/g, MgCO₃ has the specific surface area of 35 to 100 m²/g, and MgCO₃ has a flake-like structure.

A method of manufacturing a paste for an internal electrode including an internal electrode composition of a multi-layer ceramic capacitor for a vehicle according to an embodiment of the present disclosure.

As shown in FIG. 1, in the method of manufacturing a metal paste for an internal electrode of a multi-layer ceramic capacitor according to an embodiment of the present disclosure, first, metal powder is prepared (S100). The metal powder includes Ni and Sn, and is formed by mixing Ni and Sn.

Next, ceramic base substance powder is prepared (S200).

The ceramic base substance includes BaTiO₃ and MgCO₃, and a specific surface area of MgCO₃ is greater than that of BaTiO₃. For example, the specific surface area of MgCO₃ is 1.4 to 5.0 times as large as the specific surface area of BaTiO₃, BaTiO₃ of the ceramic base substance has the specific surface area of 20 to 60 m²/g, MgCO₃ has the specific surface area of 35 to 100 m²/g, and MgCO₃ has a flake-like structure.

Subsequently, an organic vehicle is prepared (S300).

The organic vehicle includes 1 to 20 wt % of a binder, 78 to 80 wt % of an organic solvent, and 0.1 to 2 wt % of a plasticizer. Here, ethyl cellulose (EC) is used as the binder, one of terpineol, alpha terpineol (a-terpineol), dihydro-terpineol, and dihydro-terpineol acetate is used as the organic solvent, and di-2-ethylhexyl phthalate (DOP) is used as the plasticizer.

Subsequently, an internal electrode composition of the multi-layer ceramic capacitor for a vehicle according to an embodiment of the present disclosure is prepared (S400). An internal electrode composition according to an embodiment is formed by mixing Ni of 79 to 91.9% by weight (wt %), Sn of 0.1 to 2.0 wt %, BaTiO₃ of 7.5 to 15 wt %, and MgCO₃ of 0.5 to 4.0 wt %.

Next, the obtained internal electrode composition of 35 to 80 wt %, an organic vehicle of 15.5 to 55 wt %, and a dispersant of 0.5 to 10 wt % are mixed (S500).

In the mixing method, 35 to 80 wt % of the internal electrode composition, 15.5 to 55 wt % of the organic vehicle, and 0.5 to 10 wt % of the dispersant are dispersed and mixed with a clear mixer, and nonylphenol ethoxylate phosphate ester is used as the dispersant.

When the internal electrode composition and the organic vehicle are dispersed and mixed with the dispersant in a 3-roll mill, the internal electrode composition and the organic vehicle are finally mixed with MDF, and then filtered to prepare a metal paste for an internal electrode (S600).

The filtration is primarily filtered using a 10 μm filter and then secondarily filtered using a 1 to 3 μm filter to prepare a metal paste for internal electrodes.

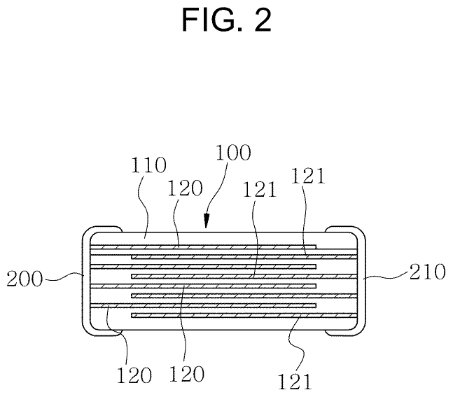

The multi-layer ceramic capacitor shown in FIG. 2 was prepared using the metal paste for an internal electrode thus obtained.

The multi-layer ceramic capacitor shown in FIG. 2 includes a ceramic fired body 100 and a pair of external electrodes 200 and 210.

The ceramic fired body 100 includes a dielectric 110 and a plurality of internal electrodes 120 and 121 formed to cross each other on the inside of the dielectric 110.

The pair of external electrodes 200 and 210 are selectively connected to the plurality of internal electrodes 120 and 121, respectively. For example, the external electrode 200 is connected to each of the plurality of internal electrodes 120, and the external electrode 210 is formed to be connected to each of the plurality of internal electrodes 121.

The thickness T of each of the internal electrodes 120 and 121 connected to the external electrodes 200 and 210 was 1 μm or less, and was manufactured using the internal electrode metal paste including the internal electrode composition of the multi-layer ceramic capacitor for a vehicle according to the embodiment of the present disclosure described above.

The external electrodes 200 and 210 are formed by plating Ni on surfaces thereof using a wet barrel plating method and then plating Sn.

In order to test the product characteristics of the multi-layer ceramic capacitor manufactured using the internal electrode metal paste including the internal electrode composition of the multi-layer ceramic capacitor for a vehicle according to the embodiment of the present disclosure, Experimental Examples 1 to 3 were prepared as shown in Tables 1 to 3, respectively.

TABLE 1

| | | | | BaTiO₃ | |
|---|---|---|---|---|---|
| | | Ni (wt %) | Sn (wt %) | (wt %) | MgCO₃ (wt %) |
| Experimental | Comparative | 92.5 | 0.0 | 7.5 | 0.0 |
| Example 1 | Example 1 | | | | |
| | Comparative | 90.0 | 0.0 | 10.0 | 0.0 |
| | Example 2 | | | | |
| | Comparative | 87.5 | 0.0 | 12.5 | 0.0 |
| | Example 3 | | | | |
| | Comparative | 85.0 | 0.0 | 15.0 | 0.0 |
| | Example 4 | | | | |
| | Comparative | 80.0 | 0.0 | 20.0 | 0.0 |
| | Example 5 | | | | |

Experimental Example 1 of Table 1 shows multi-layer ceramic capacitors prepared according to Comparative Examples 1 to 5. The multi-layer ceramic capacitors according to Comparative Examples 1 to 5 were manufactured in the same manner as the multi-layer ceramic capacitor shown in FIG. 2, but Ni and BaTiO₃ were used as the internal electrode compositions used to form the plurality of internal electrodes 120 and 121.

TABLE 2

| | | | | BaTiO₃ | MgCO₃ |
|---|---|---|---|---|---|
| | | Ni (wt %) | Sn (wt %) | (wt %) | (wt %) |
| Experimental | Example 1 | 89.9 | 0.1 | 10 | 0.0 |
| Example 2 | Example 2 | 89.5 | 0.5 | 10 | 0.0 |
| | Example 3 | 89.1 | 1.0 | 10 | 0.0 |
| | Example 4 | 88.7 | 1.5 | 10 | 0.0 |
| | Example 5 | 88.2 | 2.0 | 10 | 0.0 |
| | Example 6 | 89.5 | 0.0 | 10 | 0.5 |
| | Example 7 | 89.1 | 0.0 | 10 | 1.0 |
| | Example 8 | 88.2 | 0.0 | 10 | 2.0 |
| | Example 9 | 87.3 | 0.0 | 10 | 3.0 |
| | Example 10 | 86.4 | 0.0 | 10 | 4.0 |
| | Example 11 | 88.6 | 1.0 | 10 | 0.5 |
| | Example 12 | 88.2 | 1.0 | 10 | 1.0 |
| | Example 13 | 87.3 | 1.0 | 10 | 2.0 |
| | Example 14 | 86.4 | 1.0 | 10 | 3.0 |
| | Example 15 | 85.6 | 1.0 | 10 | 4.0 |
| | Example 16 | 89.0 | 0.1 | 10 | 1.0 |
| | Example 17 | 88.6 | 0.5 | 10 | 1.0 |
| | Example 18 | 88.2 | 1.0 | 10 | 1.0 |
| | Example 19 | 87.8 | 1.5 | 10 | 1.0 |
| | Example 20 | 87.3 | 2.0 | 10 | 1.0 |

Experimental Example 2 of Table 2 shows multi-layer ceramic capacitors prepared according to Examples 1 to 20. The multi-layer ceramic capacitors according to Examples 1 to 20 were each prepared in the same manner as the multi-layer ceramic capacitor illustrated in FIG. 2, but Ni, Sn, BaTiO₃, and MgCO₃ were used as internal electrode compositions.

The multi-layer ceramic capacitors according to Examples 1 to 5 of Experimental Example 2 were prepared by changing the amount of Ni and Sn added while the amount of BaTiO₃ added was fixed at 10 wt %, excluding MgCO₃ from the internal electrode compositions.

The multi-layer ceramic capacitors according to Examples 6 to 10 of Experimental Example 2 were prepared by changing the amount of Ni and MgCO₃ added while the amount of BaTiO₃ added was fixed at 10 wt %, excluding Sn from the internal electrode compositions.

The multi-layer ceramic capacitors according to Examples 11 to 15 of Experimental Example 2 were prepared by changing the amount of Ni and MgCO₃ added while the amount of BaTiO₃ added was fixed at 10 wt %, and the amount of Sn added was fixed at 1 wt %, as the internal electrode compositions.

The multi-layer ceramic capacitors according to Examples 16 to 20 of Experimental Example 2 were prepared by changing the amount of Ni and Sn added while the amount of BaTiO₃ added was fixed at 10 wt %, and the amount of MgCO₃ added was fixed at 1 wt %, as the internal electrode compositions.

MgCO₃ used in Experimental Example 2 had a flake-like structure.

TABLE 3

| | | | | BaTiO₃ | MgCO₃ |
|---|---|---|---|---|---|
| | | Ni (wt %) | Sn (wt %) | (wt %) | (wt %) |
| Experimental | Example 21 | 91.9 | 0.1 | 7.5 | 0.5 |
| Example 3 | Example 22 | 88.5 | 0.5 | 10.0 | 1.0 |
| | Example 23 | 84.5 | 1.0 | 12.5 | 2.0 |
| | Example 24 | 80.5 | 1.5 | 15.0 | 3.0 |
| | Example 25 | 74.1 | 2.0 | 20.0 | 4.0 |

Experimental Example 3 of Table 3 shows multi-layer ceramic capacitors prepared according to Examples 21 to 25. The multi-layer ceramic capacitors according to Examples 21 to 25 were each manufactured in the same manner as the multi-layer ceramic capacitor shown in FIG. 2. However, Ni, Sn, BaTiO₃, and MgCO₃ were used as internal electrode compositions, and each addition amount was changed as illustrated in Table 3, and MgCO₃ of a flake-like structure was used.

The internal electrode composition of the multi-layer ceramic capacitor according to Example 21 of Experimental Example 3 used BaTiO₃ of a specific surface area of 20 m²/g, and MgCO₃ of a specific surface area of 35 m²/g, and a specific surface area of MgCO₃ is 1.7 times as large as that of BaTiO₃.

The internal electrode composition of the multi-layer ceramic capacitor according to Example 22 of Experimental Example 3 used BaTiO₃ of a specific surface area of 60 m²/g, and MgCO₃ of a specific surface area of 90 m²/g, and a specific surface area of MgCO₃ is 1.5 times as large as that of BaTiO₃.

The internal electrode composition of the multi-layer ceramic capacitor according to Example 23 of Experimental Example 3 used BaTiO₃ of a specific surface area of 40 m²/g, and MgCO₃ of a specific surface area of 80 m²/g, and a specific surface area of MgCO₃ is 2.0 times as large as that of BaTiO₃.

The internal electrode composition of the multi-layer ceramic capacitor according to Example 24 of Experimental Example 3 used BaTiO₃ of a specific surface area of 30 m²/g, and MgCO₃ of a specific surface area of 90 m²/g, and a specific surface area of MgCO₃ is 3.0 times as large as that of BaTiO₃.

The internal electrode composition of the multi-layer ceramic capacitor according to Example 25 of Experimental Example 3 used BaTiO₃ of a specific surface area of 20 m²/g, and MgCO₃ of a specific surface area of 100 m²/g, and a specific surface area of MgCO₃ is 5.0 times as large as that of BaTiO₃.

Characteristics tests of Capacitance [/F], Dissipation Factor (DF) [%], Breakdown Voltage (BDV) [V/μm], Coverage [%], and Mean Time To Failure (MTTF) [year] were performed for the multi-layer ceramic capacitors prepared according to Experimental Examples 1 to 3 described above, and the results are shown in Tables 4 to 6.

TABLE 4

| | | Capacitance | DF | BDV | | Coverage | |
|---|---|---|---|---|---|---|---|
| | | [μF] | [%] | [V/μm] | | [%] | MTTF |
| Experimental | Comparative | 23.5 | 5.8 | 93 | 85.0 | 24 | |
| Example 1 | Example 1 | | | | | | |
| | Comparative | 22.6 | 5.2 | 112 | 92.5 | 57 | |
| | Example 2 | | | | | | |
| | Comparative | 21.8 | 4.8 | 113 | 93.1 | 60 | |
| | Example 3 | | | | | | |
| | Comparative | 20.5 | 4.2 | 117 | 93.5 | 62 | |
| | Example 4 | | | | | | |
| | Comparative | 18.5 | 4.0 | 118 | 94.2 | 68 | |
| | Example 5 | | | | | | |

As shown in Table 4, it can be seen that the multi-layer ceramic capacitors prepared according to Comparative Examples 1 to 5 of Experimental Example 1 increased BDV, coverage, and MTTF characteristics but decreased capacitance or DF when Ni was reduced and the amount of BaTiO₃ added was increased in the internal electrode compositions.

TABLE 5

| | | Capaci- | | | Cover- | |
|---|---|---|---|---|---|---|
| | | tance | DF | BDV | age | |
| | | [μF] | [%] | [V/μm] | [%] | MTTF |
| Experimental | Example 1 | 22.4 | 5.1 | 114 | 93.0 | 88 |
| Example 2 | Example 2 | 22.1 | 4.9 | 115 | 93.4 | 105 |
| | Example 3 | 22.0 | 4.9 | 118 | 93.8 | 148 |
| | Example 4 | 20.1 | 4.1 | 118 | 92.7 | 150 |
| | Example 5 | 19.4 | 4.0 | 120 | 92.6 | 155 |
| | Example 6 | 22.7 | 5.3 | 113 | 93.2 | 68 |
| | Example 7 | 22.9 | 5.4 | 117 | 93.5 | 92 |
| | Example 8 | 20.5 | 4.2 | 117 | 94.2 | 95 |
| | Example 9 | 19.4 | 4.0 | 118 | 94.8 | 98 |
| | Example 10 | 18.5 | 4.0 | 120 | 95.2 | 105 |
| | Example 11 | 22.5 | 5.1 | 118 | 93.8 | 148 |
| | Example 12 | 20.6 | 4.3 | 127 | 93.7 | 146 |
| | Example 13 | 19.9 | 4.1 | 127 | 93.5 | 148 |
| | Example 14 | 19.4 | 4.0 | 128 | 94.2 | 150 |
| | Example 15 | 17.7 | 4.1 | 129 | 94.8 | 153 |
| | Example 16 | 22.6 | 5.2 | 118 | 93.4 | 108 |
| | Example 17 | 22.8 | 5.3 | 128 | 94.2 | 145 |
| | Example 18 | 20.6 | 4.3 | 127 | 93.7 | 146 |
| | Example 19 | 19.9 | 4.1 | 129 | 94.8 | 155 |
| | Example 20 | 19.7 | 4.1 | 126 | 95.1 | 165 |

As shown in Table 5, the multi-layer ceramic capacitors prepared according to Examples 1 to 20 of Experimental Example 2 show the similar rates of change in capacitance or DF depending on the amount of Ni and BaTiO₃ added in the internal electrode composition, but show enhanced characteristics of BDV, coverage, and MTTF, when compared to the Comparison Examples 1 to 5 of Experimental Example 1.

TABLE 6

| | | Capaci- | | | | |
|---|---|---|---|---|---|---|
| | | tance | DF | BDV | Coverage | |
| | | [μF] | [%] | [V/μm] | [%] | MTTF |
| Experimental | Example | 20.6 | 5.20 | 121 | 94.4 | 100 |
| Example 3 | 21 | | | | | |
| | Example | 21.8 | 4.9 | 121 | 94.2 | 135 |
| | 22 | | | | | |
| | Example | 21.2 | 4.2 | 127 | 93.9 | 140 |
| | 23 | | | | | |
| | Example | 22.0 | 4.4 | 127 | 95.3 | 151 |
| | 24 | | | | | |
| | Example | 21.0 | 5.1 | 129 | 95.5 | 145 |
| | 25 | | | | | |

As shown in Table 6, the multi-layer ceramic capacitors prepared according to Examples 21 to 25 of Experimental Example 3 show the similar rates of change in capacitance or DF depending on the amount of Ni and BaTiO₃ added in the internal electrode composition, when compared to the Comparison Examples 1 to 5 of Experimental Example 1, but show enhanced characteristics of BDV, coverage, and MTTF, as in Examples 1 to 20 of Experimental Example 2, when compared to the Comparison Examples 1 to 5 of Experimental Example 1.

As described above, the internal electrode composition of a multi-layer ceramic capacitor for a vehicle, according to the present disclosure, prevents coverage characteristics from being reduced due to a sintering delay of an internal electrode, while minimizing the content of a ceramic base substance such as BaTiO₃ for controlling firing shrinkage rates between Ni metal and dielectric ceramic generated during sintering, and prevents the diffusion of BaTiO₃ to the dielectric, thereby preventing the thickness of the dielectric from increasing, and thus increasing the withstand voltage or capacity of the multi-layer ceramic capacitor or reducing the leakage current, to accordingly improve reliability by enhancing high-temperature insulation resistance characteristics.

In addition, the internal electrode composition of a multi-layer ceramic capacitor for a vehicle, according to the present disclosure, minimizes sintering and reactivity with the dielectric by adding MgCO₃ to a ceramic base substance, although a less amount of BaTiO₃, which is used as the ceramic base substance, is added, to thereby improve the reliability of multi-layer ceramic capacitor products that may increase the capacity of multi-layer ceramic capacitors or reduce leakage current. In addition, the internal electrode composition of a multi-layer ceramic capacitor for a vehicle, according to the present disclosure, forms an insulating active layer (not shown) between a dielectric and an internal electrode interface by adding tin (Sn) to metal powder, to thereby increase the reliability of the product of the multi-layer ceramic capacitor.

The internal electrode composition of a multi-layer ceramic capacitor for a vehicle according to the present disclosure is applied to the industry of manufacturing a multi-layer component device.

1. An internal electrode composition of a multi-layer ceramic capacitor for a vehicle comprising:
metal powder including Ni and Sn; and
a ceramic base substance including BaTiO₃ and MgCO₃, wherein
Ni of 79 to 91.9% by weight (wt %), Sn of 0.1 to 2.0 wt %, BaTiO₃ of 7.5 to 15 wt %, and MgCO₃ of 0.5 to 4.0 wt %, are mixed, and
a specific surface area of MgCO₃ is greater than a specific surface area of BaTiO₃.

2. The internal electrode composition of claim 1, wherein the specific surface area of MgCO₃ is 1.4 to 5.0 times as large as the specific surface area of BaTiO₃.

3. The internal electrode composition of claim 1, wherein the specific surface area of BaTiO₃ is 20 to 60 m²/g.

4. The internal electrode composition of claim 1, wherein the specific surface area of MgCO₃ is 35 to 100 m²/g.

5. The internal electrode composition of claim 1, wherein MgCO₃ has a flake-like structure.
